(19) United States
(12) Patent Application Publication
(10) Pub. No.: US 2003/0156548 A1
(43) Pub. Date: Aug. 21, 2003

(54) Methods and systems for testing throughput of a packet-based communications node

(76) Inventor: Kevin Allen Sapp, Apex, NC (US)

Correspondence Address: JENKINS & WILSON, PA, 3100 TOWER BLVD, SUITE 1400, DURHAM, NC, 27707, US

(21) Appl. No.: 10/077,729

(22) Filed: Feb. 15, 2002

(51) Int. Cl. H04L 12/26

(52) U.S. Cl. 370/252; 370/469

(57) ABSTRACT

Methods and systems for testing throughput of a packet-based communications node include a packet generator, a communication protocol stack, and a packet replicator. The packet generator generates packets of user data to be sent to a device under test. The packets are passed through layers of the communications protocol stack. The packet replicator resides within at least one of the layers and copies predetermined packets in accordance with a user specified key value. The packet replicator replicates the packets to a device under test, such as a GPRS node, and bypasses at least some of the layers of the communications protocol stack.

### TECHNICAL FIELD

The present invention relates to methods and systems for testing throughput of packet-based communications nodes. More particularly, the present invention relates to methods and systems for testing throughput of packet-based communications nodes, such as general packet radio service (GPRS) nodes, in a manner that increases the speed at which test packets can be generated.

### RELATED ART

General packet radio service or GPRS is a European Technical Standards Institute (ETSI) standard that defines the implementation of packet data services on a global system for mobile communications (GSM) network. The general packet radio service provides GSM bearer services for carrying voice, data, and signaling information in packetized format over a GSM network. Users in a GPRS network can send and receive data in an end-to-end packet transfer mode without utilizing the network resources required for circuit switched mode. GPRS networks provide both connectionless and connection-oriented services. In addition, GPRS networks allow users to request quality of service parameters for different types of data packets. The quality of service parameters include service precedence, reliability, delay, and throughput. These and other requirements of the GPRS protocol can be found in Digital Cellular Telecommunications System (phase 2+); General Packet Radio Service (GPRS); Service Descriptions; Stage 1 (GSM 02.60 version 6.1.1 release 1997), the disclosure of which is incorporated herein by reference in its entirety.

The GPRS tunneling protocol (GTP) handles the flow of user packet data and signaling information between gateway GPRS support nodes (GGSNs) and signaling GPRS support nodes (SGSNs). The interface between SGSNs and GGSNs is referred to as the Gn interface if the SGSN and the GGSN are in the same public land mobile network (PLMN). The interface between the SGSN and the GGSN is referred to as the Gp interface if the SGSN and the GGSN are in different public land mobile networks. In short, the gateway tunneling protocol allows multiprotocol packets to be tunneled through the GPRS backbone between GPRS support nodes. The GPRS tunnel protocol is described in Digital Cellular Telecommunications System (phase 2+); General Packet Radio Service (GPRS); GPRS Tunneling Protocol (GTP) across the Gn and Gp Interface (3GPP TS 09.60 version 7.8.0 release 1998), the disclosure of which is incorporated herein by reference in its entirety.

FIG. 1 is a protocol layer diagram illustrating an exemplary protocol stack that may be used to transfer user data between an SGSN and a GGSN in a GPRS network. In the protocol stack illustrated in FIG. 1 user data 100 may be any type of user data, such as signaling information or simulated voice. GTP layer 102 allows multiprotocol user data to be transferred over the core GPRS network. User datagram protocol (UDP) layer 104 provides connectionless delivery of user datagrams over Internet protocol (IP). IP layer 106 provides network layer addressing and routing of datagrams. Multiprotocol AAL encapsulation layer 108 performs multiprotocol encapsulation over ATM adaptation layer 5. ATM adaptation layer 5 110 interfaces between higher layers and 108 and ATM layer 112. AAL5 layer 110 segments data into 48 byte units for transmission over the network in ATM cells. ATM layer 112 generates ATM headers, adds the headers to data received from AAL5 layer 110 to create ATM cells, and passes the cells to physical layer 114. Physical layer 114 transmits data over a physical interface, such as a transmission line or an optical fiber.

When a GPRS network element, such as an SGSN, desires to send data to another network element, such as a GGSN, protocol software on the network node must generate headers and perform computationally-intensive calculations, such as checksum and CRC calculations, for each of the layers illustrated in FIG. 1 for every packet being sent to the destination. For example, a GGSN may be required to generate a GTP header, a UDP header, an IP header, a multiprotocol AAL encapsulation header, an AAL5 header and trailer before delivering the information to ATM layer 112. The generation of these headers not only involves inserting standard information, such as network address information, but it also involves performing computationally-intensive calculations, such as checksums, in the case of UDP and IP headers. Accordingly, sending data over a GPRS network using a protocol stack, such as that illustrated in FIG. 1 can be processor-intensive.

The increased processor cycles required to perform protocol layer functions is particularly problematic in network testing. For example, in order to verify the performance of a GPRS network element before placing the GPRS network element in a live network, it may be desirable to test quality of service parameters associated with the network element, such as throughput, delay, or any of the other quality of service parameters mentioned above. In order to test throughput, and in particular, maximum throughput, it is desirable to generate a stream of back-to-back packets at the line rate. In some instances, for example when the underlying physical layer protocol is OC-3, the line rate can be as high as 155.52 gigabits per second. Even an electrical interface, such as gigabit Ethernet, can place great demands on the test system in generating packets at line rate. More particularly, because each packet must pass vertically through the entire protocol stack, generating packets at line rate can require special-purpose processors or even multiple processors, which increase the cost of the test system. Accordingly, in light of the difficulties associated with conventional test systems, there exists a need for improved methods and systems for testing GPRS communication devices.

### DISCLOSURE OF THE INVENTION

The present invention includes methods and systems for testing throughput of a packet-based communications node that reduce the amount of processing required in formulating test packets. As used herein, the term packet refers to any type of protocol data unit that includes address information indicating where the packet is to be delivered. Examples of packets include GPRS packets, IP packets, ATM cells, etc. According to one aspect, the invention includes a packet-based communications node test system. The test system includes a packet generator for generating user data to be inserted in test packets. A communication protocol stack inserts appropriate headers or trailers on the user data generated by the packet generator. A packet replicator receives packets from layers of the communications protocol stack above the packet replicator, stores the packets, and replicates the packets to the node being tested at predetermined intervals specified by the user. Because the test system is capable of sending packets at predetermined intervals specified by the user without requiring the packet to pass vertically through all of the layers of the communication protocol stack, the processing load required to test the throughput of a packet-based communications node is reduced.

Accordingly, it is an object of the invention to provide improved methods and systems for testing packet-based communications nodes, such as GPRS nodes.

It is another object of the invention to provide methods and systems for testing packet-based communications nodes that reduce the amount of processing required to generate a stream of test packets.

Some of the objects of the invention having been stated hereinabove, other objects will become evident as the description proceeds when taken in connection with the accompanying drawings as best described hereinbelow.

### BRIEF DESCRIPTION OF THE DRAWINGS

A description of preferred embodiments of the invention will now proceed with reference to the accompanying drawings of which;

FIG. 1 is a protocol layer diagram of a conventional GPRS protocol stack used to communicate user data between a GGSN and an SGSN;

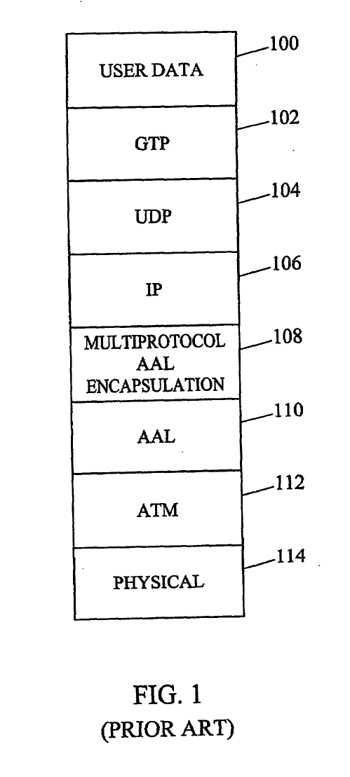

FIG. 2 is a network diagram of a GPRS network including a system for testing packet-based communications nodes in the GPRS network according to an embodiment of the present invention;

FIG. 3 is a block diagram of an exemplary internal architecture for a packet-based communications node test system according to an embodiment of the present invention;

FIG. 4 is a protocol layer diagram of a GPRS protocol stack for testing a GPRS node over the Gn Interface according to an embodiment of the present invention;

FIG. 5 is a protocol layer diagram illustrating a GPRS protocol stack for testing a GPRS node over an lu interface according to an embodiment of the present invention;

FIG. 6 is a state machine illustrating exemplary states for testing throughput of a packet-based communications node according to an embodiment of the present invention;

FIG. 7 is a flow chart illustrating exemplary steps that may be performed by a packet replicator in testing a packet-based communications node according to an embodiment of the present invention;

FIG. 8 is a timing diagram illustrating a packet repeat count feature of a packet-based communications node test system according to an embodiment of the present invention; and

FIG. 9 is a class diagram illustrating exemplary classes associated with packet replicator software according to an embodiment of the present invention.

### DETAILED DESCRIPTION OF THE INVENTION

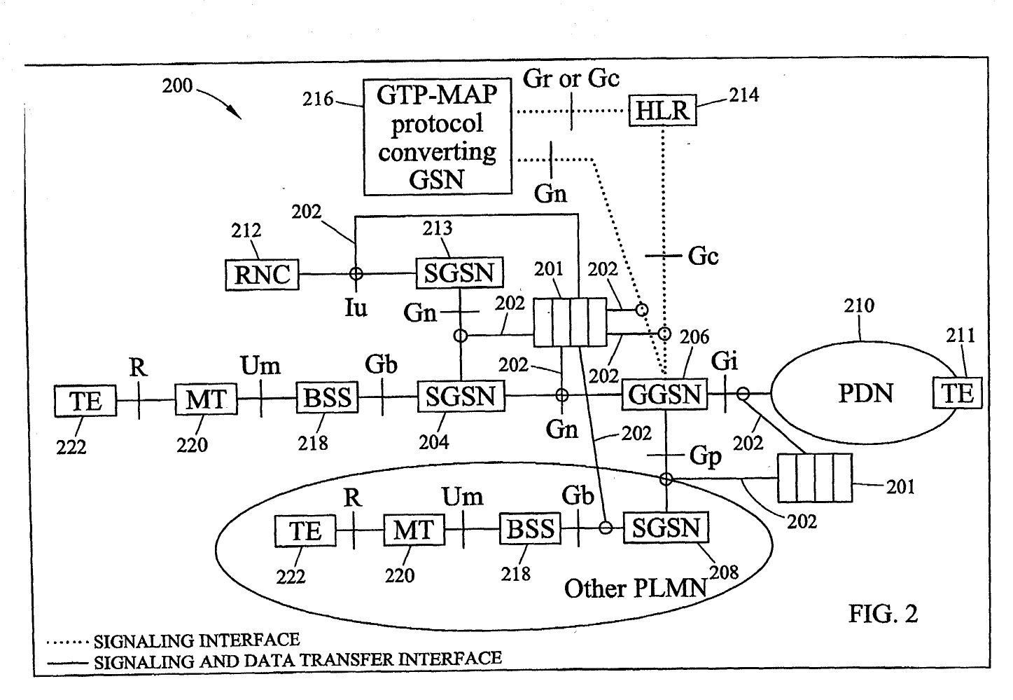

FIG. 2 illustrates an exemplary operating environment for the methods and systems for testing packet-based communications nodes according to embodiments of the present invention. In FIG. 2, GPRS network 200 includes a plurality of components used for packet-based communications between end users. A plurality of test systems 201 may be positioned at predetermined locations in the network to insert simulated traffic into the network and thereby test one or more GPRS nodes. Test systems 201 may include link probes 202 for non-intrusively inserting simulated message traffic onto interfaces between the network elements and for monitoring traffic between the network elements. For example, test systems 201 may insert simulated traffic on the Gn interface between an SGSN 204 and a GGSN 206 in the same PLMN or on a Gp interface between GGSN 206 and another SGSN 206 located in another PLMN. In an alternate embodiment, test system 201 may insert simulated traffic on a Gi interface between a GGSN 206 and a packet data network 210 including terminal equipment 211, such as a computer. And yet another alternate embodiment, test system 201 may insert simulated traffic on an lu interface between a radio network controller (RNC) 212 and an SGSN 213. In yet another alternate embodiment test system 201 may insert simulated traffic on a Gc interface between a GGSN 206 and an HLR 214 or on a Gn interface between GGSN 206 and GTP-MAP protocol converting GSN 216.

The present invention is not limited to GPRS protocols. The methods and systems described herein can be used to test a communications device using any packet-based protocol whose packets can be replicated. Exemplary protocols that may be used include IP, UDP, GTP, RFC1483, luVoice, luUDI, and proprietary packet based protocols.

Additional components of the GPRS network illustrated in FIG. 2 include base station systems 218, mobile terminal 220, and terminal equipment 222. Base station system 218 communicates with mobile terminal 220 over the air interface. Terminal equipment 222 includes hardware and software for generating packet data to be sent over GPRS network 200. Mobile terminal 220 and terminating equipment 222 may be implemented in a portable communications device, such as a mobile telephone.

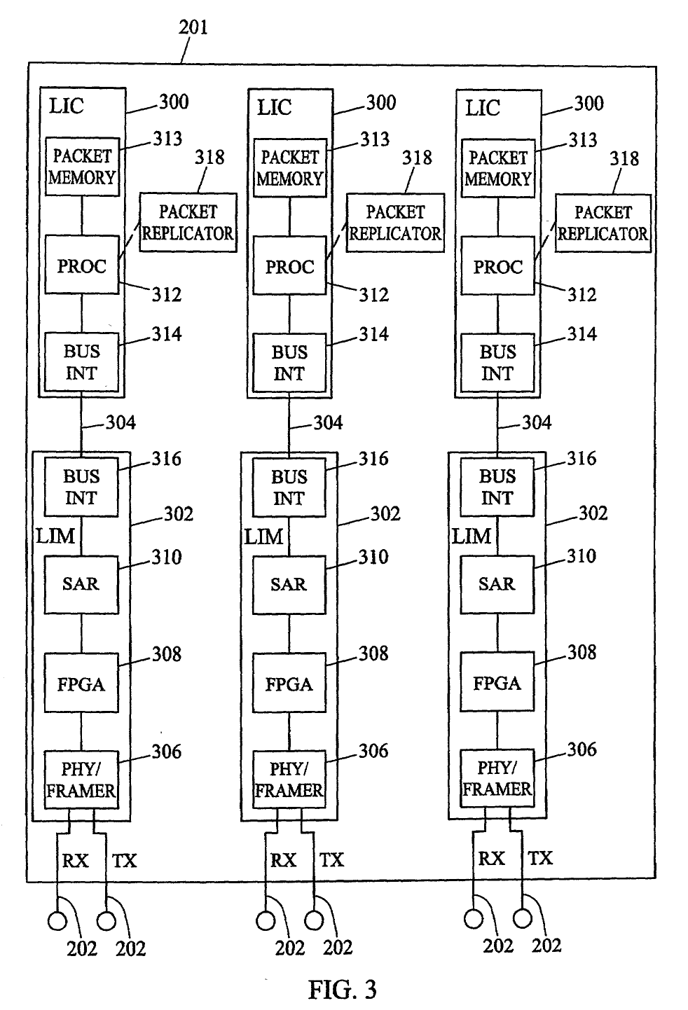

FIG. 3 is a block diagram of a test system 201 according to an embodiment of the present invention. In FIG. 3, test system 201 includes a plurality of link interface controllers (LICs) 300 and link interface modules (LIMs) 302. In general, LICs 300 execute test applications and LIMs 302 interface directly with communication links via link probes 202. In the illustrated example, each LIC 300 is connected to a LIM 302 via a bus 304. Bus 304 may be any type of bus that allows communication between LICs 300 and LIMs 302. In a preferred embodiment, bus 304 comprises a CompactPCI™ bus. The CompactPCI™ may be used for interprocessor communications between LICs 300 and LIMs 302.

From a hardware perspective, each LIM 302 includes a physical layer/framer chip 306 for implementing physical layer and framing functions. For example, physical/framer chip 306 may provide an optical interface, such as a SONET interface or an electrical interface, such as an Ethernet or a DS-n interface. Each LIM 302 includes an FPGA or other special-purpose hardware device 308 for performing additional link interface functions. For example, each FPGA 308 may implement an ATM layer if the communication being tested is an ATM link. Alternatively, each FPGA 308 may implement an Internet protocol (IP) layer if the protocol of the network being tested is IP. Each LIM may also include segmentation and reassembly (SAR) module 310 for implementing the SAR sublayer of AAL layer 110 illustrated in FIG. 2.

Bus interfaces 314 and 316 are chips that control communications between LICs 300 and LIMs 302 via bus 304. As stated above, in a preferred embodiment, bus 304 comprises a CompactPCI™ bus. Accordingly, bus interfaces 314 and 316 may be commercially available CompactPCI™ chips.

According to an important aspect of the invention, processors 312 on LICs 300 each include a packet replicator 318. Packet replicator 318 may include software that replicates packets received from protocol layers above the protocol layer in which packet replicator 318 is implemented and forwards the replicated packets to the GPRS network element being tested without requiring that the upper protocol layer functions be repeated for each packet. The functions of packet replicator 318 will be described in further detail below.

Test system 201 may be connected to a specific-purpose computer (not shown) via a wide or local area network so that a user can execute and modify tests and monitor test results. A plurality of test systems 201 may be located at different sites in a network to test multiple GPRS nodes, as illustrated in FIG. 2. In such an embodiment, the test systems may each be controllable by a single centrally located computer and/or by separate computers located at individual test sites. Both local and remote control of test systems 201 is intended to be within the scope of the invention.

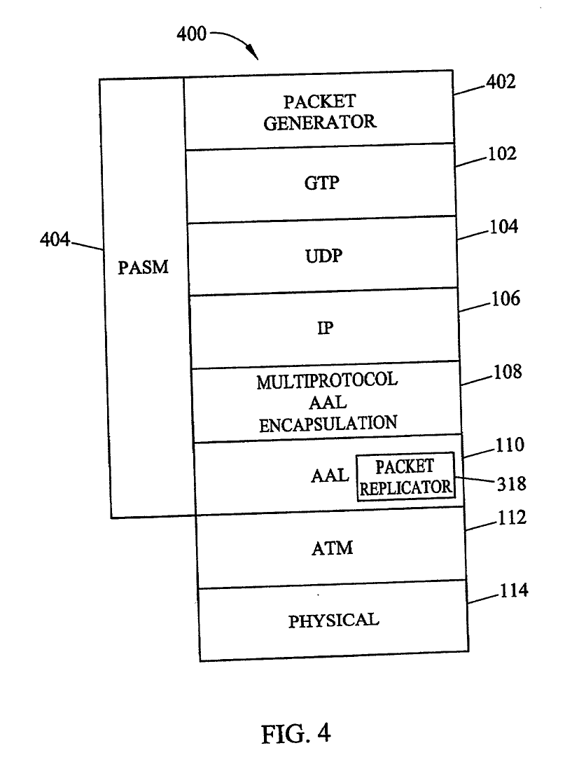

FIG. 4 illustrates an exemplary protocol stack that may be implemented by test system 201 in order to test the Gn interface between an SGSN and a GGSN. In the illustrated example, protocol stack 400 includes ATM layer 112 and physical layer 114. Physical layer 114 may be any suitable optical or electrical interface, such as a SONET or Ethernet interface. ATM layer 112 performs asynchoronous transfer mode communications functions, such as transmitting and receiving 53 byte cells over a network interface. ATM adaptation layer 110 buffers the upper layers from ATM layer 112. An exemplary adaptation layer suitable for testing throughput of a packet-based communications node includes ATM adaptation layer 5 (AAL5). Other adaptation layers may be used without departing from the scope of the invention. For example, in an alternate embodiment, AAL0, AAL1, AAL2, AAL3/4, or SAAL may be used.

In the illustrated example, packet replicator 318 is implemented in AAL layer 110. Accordingly, packet replicator 318 may receive packets originating from layers above AAL layer 110, store copies of such packets, and send such packets over the network interface at predetermined intervals. In the protocol stack illustrated in FIG. 4, packet replicator 318 is preferably implemented in an AAL device driver associated with AAL layer 110, so that processing overhead is minimized. Because packet replicator 318 replicates packets while bypassing layers above ML layer 110, the amount of processing required to generate each packet is reduced. As a result, the speed at which test packets are generated is increased.

Multiprotocol AAL encapsulation layer 108 encapsulates multiple protocol packets before the packets are passed to AAL layer 110. An example protocol that may be implemented by multiprotocol encapsulation layer 108 is the multiprotocol encapsulation protocol, as described in IETF RFC 1483, the disclosure of which is incorporated herein by reference in its entirety. UDP layer 104 and Internet protocol layer 106 respectively implement datagram and network layer functions in accordance with the UDP and IP protocols. Gateway tunneling protocol layer 102 tunnels packets between an SGSN and a GGSN.

According to the present invention, the gateway tunneling protocol header may be used by packet generator 318 to identify packets to be replicated. Packet generator 402 generates simulated packets to be sent to the device under test. The type of packets generated by packet generator 402 depends on the device being tested. For example, if the device under test is an SGSN, the packets may include signaling information, such as call setup information, or simulated voice packets. Packet generator 402 creates a data message of a size determined by the user. The payload may be a fixed or variable, e.g., read from a file. The data message may contain a destination address. This address is used by the SGSN and GGSN to route the data to the appropriate destination. The information in the data message can be any user-specified data, such as voice, signaling, packet data, short message service data, an audio frame, a video frame, etc., provided that it uses the same connection. Finally, protocol adaptable state machine, (PASM) 404 controls the overall operations of protocol stack 400.

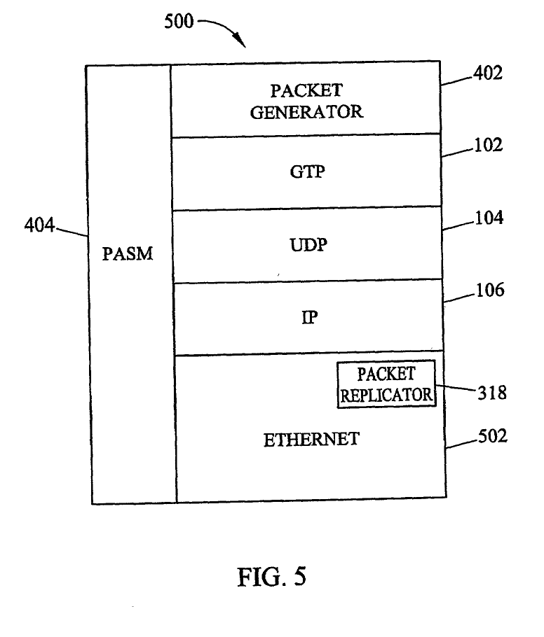

FIG. 5 illustrates an exemplary protocol stack that may be implemented by a test system 201 according to an alternate embodiment of the present invention. In FIG. 5, protocol stack 500 includes an Ethernet layer 502, rather than an ATM layer, as described with respect to FIG. 4. Protocol stack 500 may be implemented in order to test the Gi Interface of a GGSN, as illustrated in FIG. 2. Like the protocol stack illustrated in FIG. 4, protocol stack 500 includes a packet generator layer 402, a GTP layer 102, a UDP layer 104, and an IP layer 106. Packet replicator 318 is implemented in Ethernet layer 502. In the protocol stack illustrated in FIG. 5, packet replicator 318 is preferably implemented in an Ethernet device driver associated with Ethernet layer 502 to reduce processing overhead. In general, in an arbitrary protocol stack, packet replicator 318 is preferably implemented as low as possible in the stack so that overhead is minimized. When testing throughput, packet replicator 318 receives packets from protocol layers above Ethernet layer 502, stores the packet, and replicates the packet over the network interface without involving the upper layers. By replicating packets received from upper layers, packet replicator 318 greatly decreases the processing required to test a GPRS network element. As stated above with regard to FIG. 4, PASM 404 controls the overall operation of protocol stack 500.

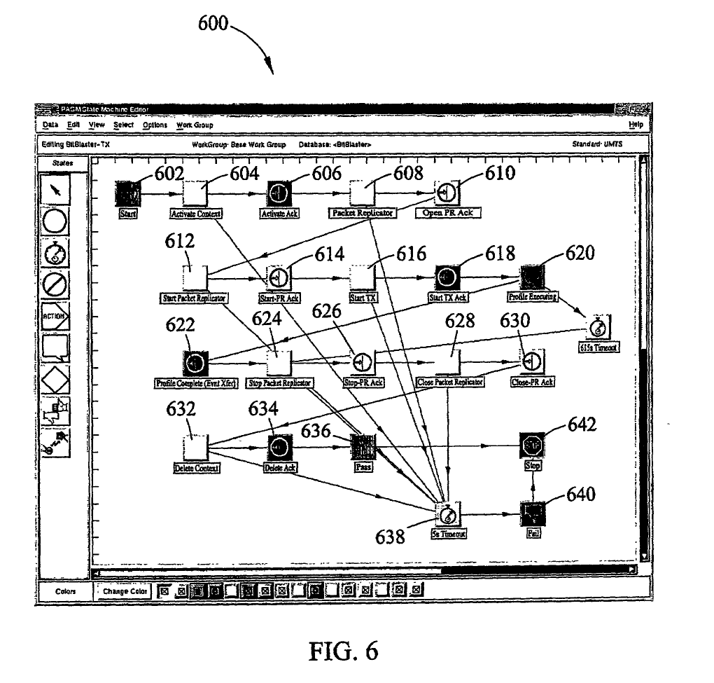

FIG. 6 is a state diagram illustrating an exemplary controller state machine 600 that may be implemented in PASM layer 404 for testing the throughput of a packet-based communications node according to an embodiment of the present invention. In FIG. 6, controller state machine 600 begins in start state 602, which indicates the start of a throughput test. In activate context state 604, controller state machine 600 sends a message to packet generator to create or activate a new context. As used herein, a context refers to an instance of a user application simulated by the packet generator. An example of a context may be a session layer communication with a desired destination. An example of a session is a connecion between two peers, such as an HTTP session. After sending the activate new context message, controller state machine 600 enters activate ACK state 606, where controller state machine 600 waits for an acknowledgement message from packet generator 402. When controller state machine 600 receives an acknowledgement from packet generator 402, controller state machine 600 enters open packet replicator state 608. In open packet replicator state 608, controller state machine 600 sends a message to packet replicator 318 instructing packet replicator 318 to open a connection. Table 1 shown below illustrates exemplary parameters that may be included in the open packet replicator message.

TABLE 1
Open packet replicator parameters and values

| Parameter | Value |
|---|---|
| Type | Currently unused |
| Key | GTPTID or IPADDR |
| Seconds | Number of seconds between |
| | messages |
| Microseconds | Number of microseconds between |
| | messages |
| Flags | Miscellaneous flags |
| ATM Reference | ATM Reference Number or VCC |
| Path ID | Optional |

In response to receiving the open packet replicator message, packet replicator 318 opens a connection with an external device and sends an open PR ACK message to controller state machine 600. In response to receiving the open PR ACK message, controller state machine 600 transitions to start packet replicator state 612.

In start packet replicator state 612, controller state machine 600 instructs packet replicator 318 to start sending data on this context at the rate specified in the start packet replicator message. After sending this message, controller state machine 600 waits for an acknowledgement from packet replicator 318. Once packet replicator 318 receives the open message, packet replicator 318 begins searching from the key specified in the open message in messages received from the higher protocol layers. Packet replicator 318 also sends an acknowledgement to the open message to the controller state machine 600, which causes controller state machine 600 to transition from start packet replicator acknowledge state 614 to start TX state 616. In start TX state 616, controller state machine 600 instructs packet generator 402 to generate a message to be sent to the device under test and controller state machine 600 then transitions to start TX ACK state 618 where controller state machine 600 waits for an acknowledgement. In response to receiving the start TX message, packet generator 402 generates a data packet and passes the data packet to GTP layer 102. GTP layer 102 adds a GTP header to the message and passes the message to IP layer 106. UDP layer 104 adds a UDP header to the message. IP layer 106 adds an IP header to the message and passes the message to multiprotocol encapsulation layer 108. Multiprotocol encapsulation layer 108 adds a multiprotocol encapsulation header to the message and passes the message to packet replicator 318. In response to receiving the message, packet replicator 318 determines whether the key in the message matches the key specified in the open packet replicator message. If there is no match, packet replicator 318 simply ignores the message. If there is a match, packet replicator 318 stores a copy of the message and replicates the copy over the connection at the specified rate bypassing layers above packet replicator 310.

Once packet generator 402 sends a message, packet generator 402 sends an acknowledgement message to controller state machine 600, which causes controller state machine 600 to transition from start TX ACK state 618 to profile executing state 620. In profile executing state 620, controller state machine 600 waits for a timer to expire defined by the test profile. When the timer expires, controller state machine 600 transitions to profile complete state 622 where it waits for a message from packet generator 402 indicating that it is finished sending packets. The waiting that occurs in state 422 may also be ended by a timer. Once a message or a timeout is received, controller state machine 600 transitions to stop packet replicator state 624. In stop packet replicator state 624, controller state machine 600 sends a message to packet replicator 318. The message includes the key and the path for which it is desired to stop sending packets. After sending the stop packet replicator message, controller state machine 600 transitions to stop PR acknowledgement state 626 where controller state machine 600 waits for an acknowledgement message from packet replicator 318. In response to receiving the stop packet replicator message, packet replicator 318 stops replicating packets over the message and sends an acknowledgement to controller state machine 600. In response to receiving the acknowledgement, controller state machine 600 transitions to close packet replicator state 628. In close packet replicator state 628, controller state machine 600 sends a message to packet replicator 318 instructing packet replicator 318 to close the connection and de-allocate resources. After sending the close packet replicator message, controller state machine 600 transitions to close packet replicator acknowledgement state 630.

In close packet replicator acknowledgement state 630, controller state machine 600 waits for an acknowledgement to the close packet replicator message. In response to receiving the close packet replicator acknowledgement message, controller state machine 600 transitions to delete context state 632. In delete context state 632, controller state machine 600 sends a delete context message to packet generator 402. Controller state machine 600 then transitions to delete context acknowledgement state 634 where it waits for an acknowledgement from packet generator 402. In response to receiving the acknowledgement message, controller state machine 600 transitions to pass state 636 where controller state machine 600 instructs the user that the test was passed.

If a failure occurs during execution of state machine 600, the failure is preferably detected and communicated to the user. One possibility for a test failure is when a timeout occurs in any of the states connected to timeout state 638. When a timeout occurs, controller state machine 600 sends a message to the user indicating that the test has failed and transitions to fail state 640. Once the test has either passed or failed, controller state machine 600 transitions to stop state 642 where the test ends.

Thus, as illustrated in FIG. 6, controller state machine 600 is a user defined state machine that controls the operation of protocol stack 400 to send packets to a device under test without requiring all of the protocol layers to be traversed when sending each packet. A similar test can be performed using the protocol stack 500 illustrated in FIG. 5 by replacing the GTP tunnel ID key parameter with an IP address parameter. Such a test may be useful in testing the Iub interface of an RNC or an SGSN as illustrated in FIG. 2. Test system 201 may implement multiple instances of state machine illustrated in FIG. 6 to simultaneously test multiple connections with the device under test. For example, controller state machine 600 may instruct packet generator 402 and packet replicator 318 to open multiple connections for the device under test. In such a test, packet replicator 318 stores multiple keys, one key for each connection. In response to receiving a packet from packet generator 402 that matches one of the keys, packet replicator 318 stores the packet in memory. Packet replicator 318 may then replicate the packet for each connection and send the packet to the device under test over each connection. Replicating multiple packets over multiple connections without using all of the layers in the protocol stack further increases the processing segments.

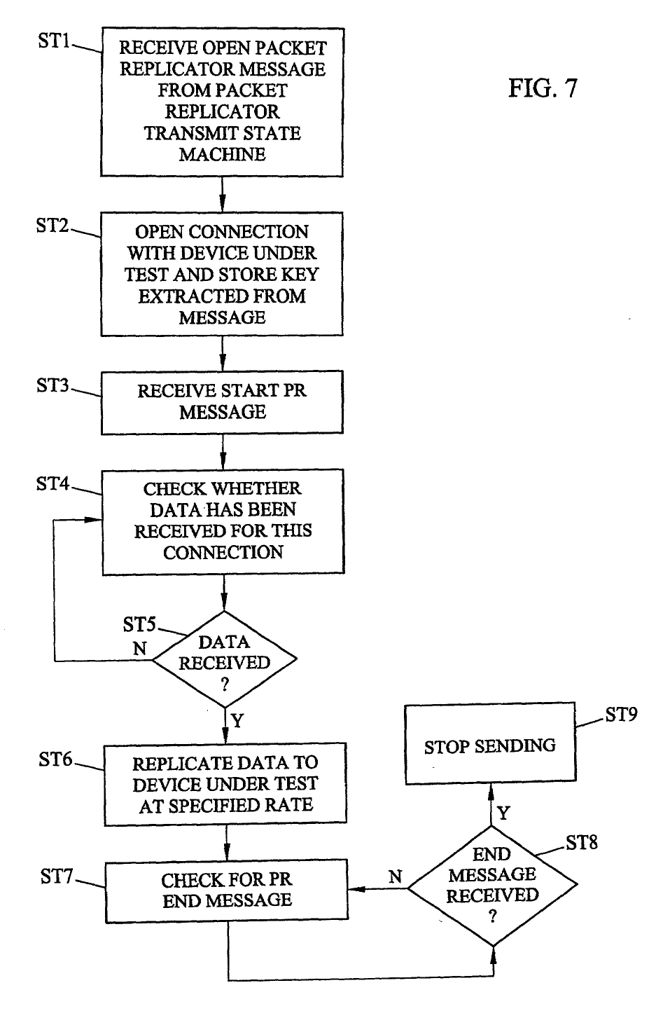

FIG. 7 is a flow chart illustrating exemplary steps performed by a packet replicator 318 in testing throughput of a GPRS node. The steps illustrated in FIG. 7 may be implemented in hardware, software, or a combination of hardware and software. For example, as discussed above, packet replicator 318 may be a software component executed by processor 312 of each LIC 300. Referring to FIG. 7, in step ST1, packet replicator 318 receives an open packet replicator message from controller state machine. In step ST2, packet replicator 318 opens a connection with the device under test and stores a key extracted from the open packet replicator message. Packet replicator 318 uses the key to analyze subsequent messages passed down the stack to determine whether these messages are to be stored and replicated to the device under test. In step ST3, packet replicator 318 receives a start packet replicator message from controller state machine 600. In response to receiving the start packet replicator message, packet replicator 318 determines whether data has been received for this connection from the upper protocol layers. This step is performed because the packet generator may begin sending packets before the packet replicator is activated. Packet replicator 318 uses the key received in the open packet replicator message to determine whether any such packets have been received. In step ST5, if data has been received, packet replicator 318 replicates data to the device under test at the specified rate. The rate may be specified in the start packet replicator message.

During the transmission and reception, packet replicator 318 may collect statistics for the number of bytes and frames transmitted and received on each connection. Errors may also be collected, e.g., indicating the number of packets that could not be transmitted due to lack of resources. These statistics may be reported to the user via an administrative interface coupled to test system 201.

Packet replicator 318 sends data to the device under test until an end packet replicator message has been received. All layers above packet replicator 318 may be deactivated, i.e., they are not required to generate additional packets for this connection. If packet replicator 318 determines in steps ST7 and ST8 that an end packet replicator message has been received, packet replicator 318 stops sending the test data. By storing and replicating packets, packet replicator 318 greatly reduces the overhead required to test a network node, such as a GPRS node.

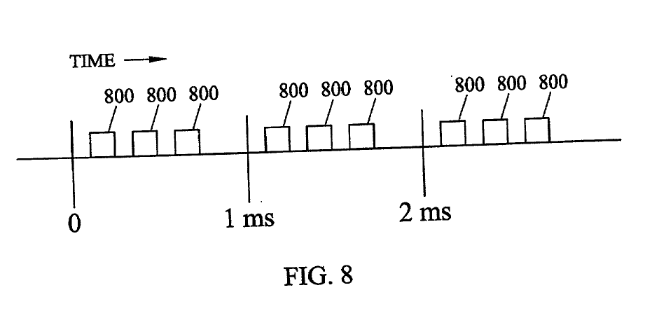

According to another aspect of the invention, packet replicator 318 includes a user controllable repeat count and repetition rate. As stated above with regard to Table 1, the repeat count and repetition rate are user parameters that may be specified in the open connection message. The repeat count controls the number of packets sent per time interval by a packet replicator 318. The time interval parameter controls the time interval at which the packets are repeated. FIG. 8 is a timing diagram that illustrates the repeat count and time interval features of packet replicator 318. In FIG. 8, the repeat count is assumed to be 3 and the repeat interval is assumed to be 1 millisecond. Accordingly, in FIG. 8, packet 800 is repeated three times during each 1 millisecond interval. Allowing the user to control the repeat count and the repeat interval increases the flexibility with which a packet-based communications node can be tested. For example, allowing the user to specify a repeat count allows the user to simulate bursty traffic conditions, which are common in packet-based communications networks.

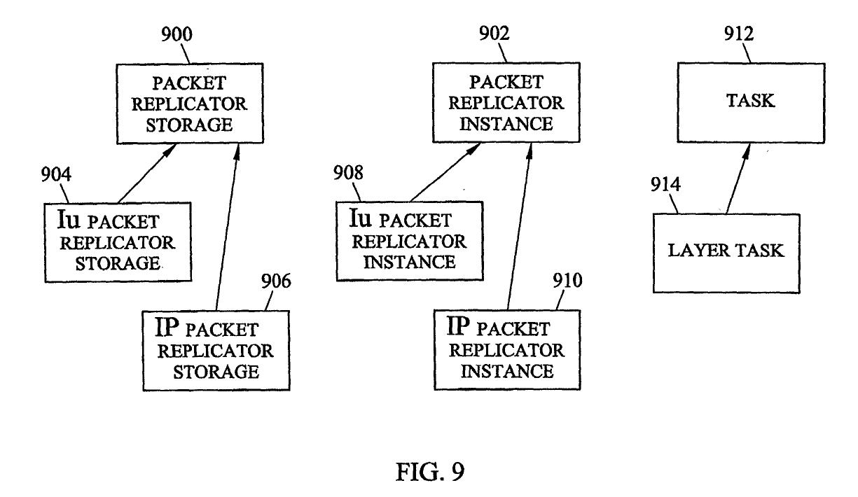

As stated above, packet replicator 318 may be implemented in software. Exemplary software programming languages in which packet replicator 318 may be implemented include object-oriented languages, such as JAVA or C++. FIG. 9 is a class diagram illustrating exemplary classes that may be used to implement packet replicator 318 in an object-oriented language, such as C++. The present invention is not limited to the class structure illustrated in FIG. 9. FIG. 9 is included merely for purposes of illustrating one example class structure that may be used to implement a packet replicator according to an embodiment of the present invention. In FIG. 9, each block represents a class. Each class includes functions and data structures for implementing a packet replicator. For example, packet replicator storage class 900 provides functions and data structures for identifying packets received from higher layers to be stored and replicated to external devices. Packet replicator instance class 902 includes functions and data structures for implementing an instance of packet replicator 318. For example, packet replicator instance class 902 may include a start( ) function for starting a packet replicator instance. Packet replicator instance class 902 may also include common information to all protocols, such as the rate, repeat count, tx bytes, tx frames, rx bytes, rx frames, and errors. Packet replicator instance class 902 may also include retransmission timers, repeat counts, and other information that is common to all or most child classes to facilitate development of additional child classes to test different interfaces.

Child classes 904, 906, 908, and 910 include functions related to replicating packets over a specific interface, such as an Iub interface or an IP interface. For example, Iu packet replicator storage class 904 provides the specific function to extract the key from an Iu interface data packet. Similarly, IP packet replicator storage class 906 contains the functions for extracting the key from a data packet for the IP interface. Classes 908 and 910 also format data to be delivered to the appropriate device driver.

Task class 912 provides threading an overall message processing for packet replicator 318. Layer task 914 is the basis for all protocol layers implemented on test system 201. For example, layer task 914 may process control messages received from PASM layer 400. These messages are referred to as primitives.

Using the hardware described above with respect to FIG. 3, without packet replicator 318, the test system was capable of sending 400 packets per second. Using this same hardware with packet replicator 318, the test system was capable of sending over 7000 packets per second, where the packets were uniform in size and sent over the same interface. The present invention may be capable of sending packets at even higher rates because SAR hardware limits the peak cell rate that can be transmitted over a connection. During testing of the present invention, the SAR peak cell rate was required to be repeatedly increased in order to keep from limiting the speed of packet replicator 318.

Thus, as illustrated above, the methods and systems for testing packet-based communications nodes elements, such as GPRS nodes, greatly reduce the amount of computation required in generating multiple test packets over conventional test methods and systems. By searching for a key in messages received from higher communication protocol stack layers, copying matching messages, and replicating the messages to a device under test, the test methods and systems according to embodiments of the invention reduce the need for creating each new packet at the application layer. Because some of the communications protocol stack layers can be bypassed, the present invention reduces overall computational overhead required to perform throughput testing and thereby increases the speed at which packets can be generated.

It will be understood that various details of the invention may be changed without departing from the scope of the invention. Furthermore, the foregoing description is for the purpose of illustration only, and not for the purpose of limitation—the invention being defined by the claims.

What is claimed is:

1. A system for testing a packet-based communications node, the system comprising:
(a) a packet generator for generating user data to be sent over a connection to a packet-based communications node under test;
(b) a communication protocol stack having layers for communicating with packet-based communications nodes over a network and adding header information to user data generated by the packet generator to form packets; and
(c) a packet replicator associated with the communication protocol stack and the packet generator for receiving packets generated by the communication protocol stack and replicating predetermined packets to the packet-based communications node under test, wherein replicating the packets includes bypassing at least one layer of the communication protocol stack.

2. The system of claim 1 wherein the communication protocol stack includes an AAL5 layer and the packet replicator resides within an AAL5 layer device driver.

3. The system of claim 1 wherein the communication protocol stack includes an Ethernet layer and the packet replicator resides in an Ethernet layer device driver.

4. The system of claim 1 wherein the packet replicator is adapted to replicate packets to the packet-based communications node under test at user-specified intervals.

5. The system of claim 4 wherein the packet replicator is adapted to repeat replication of the packets according to a user configurable repeat count during each time interval.

6. The system of claim 1 wherein the packet replicator is adapted to search for a predetermined key value in packets received from layers above the packet replicator in the communication protocol stack and to replicate only those packets that match the key value.

7. The system of claim 1 comprising a controller state machine for controlling operations of the packet generator, the communication protocol stack, and the packet replicator.

8. The system of claim 7 wherein the controller state machine includes a graphical user interface whereby a user defines states for controlling operations of the packet generator, the communication protocol stack, and the packet replicator.

9. The system of claim 1 comprising a test platform including a plurality of link interface controllers, each link interface controller including a processor and a packet memory, wherein an instance of the packet generator, the communications protocol stack, and the packet replicator is executed by each processor.

10. The system of claim 8 wherein the packet replicator is adapted to store packets received from the packet generator in the packet memory.

11. The system of claim 1 comprising a plurality of link interface modules, one link interface module coupled to each link interface controller, wherein the link interface modules implement at least a portion of the communication protocol stack.

12. A method for testing throughput of a packet-based communications node, the method comprising:
(a) generating a packet for testing a packet-based communications node;
(b) passing the packet through layers of a protocol stack and adding a header to the packet for each layer;
(c) at a predetermined layer of the protocol stack, storing a copy of the packet including information added by layers above the predetermined layer; and
(d) replicating, from the predetermined layer, copies of the packet to the packet-based communications node under test.

13. The method of claim 12 wherein replicating copies of the packet from a predetermined layer of the protocol stack includes replicating copies of the packet from an AAL5 layer of the protocol stack.

14. The method of claim 12 wherein replicating copies of the packet from a predetermined layer of the protocol stack includes replicating copies of the packet from an Ethernet layer of the protocol stack.

15. The method of claim 12 comprising establishing a plurality of connections with the packet-based communications node under test, generating packets for each connection, and replicating the packets to the packet-based communications node under test over each of the connections.

16. The method of claim 12 wherein replicating the packet to the packet-based communications node under test includes replicating the packet at user specified intervals to the packet-based communications node under test.

17. The method of claim 16 comprising repeating the packet according to a user specified repeat count during each of the predetermined intervals.

18. The method of claim 12 comprising controlling steps (a)-(e) using a user defined state machine.

19. The method of claim 12 comprising, at the predetermined layer, receiving a plurality of packets from layers above the predetermined layer in the communication protocol stack, searching the packets for a predetermined key value, and replicating packets that match the key value to the packet-based communications node under test.

20. The method of claim 12 wherein replicating the packets to the packet-based communications node under test includes replicating the packets to a gateway GPRS support node.

21. The method of claim 12 wherein replicating the packets to the packet-based communications node under test includes replicating the packets to a signaling GPRS support node.

22. The method of claim 12 wherein replicating the packets to the packet-based communications node under test includes replicating the packets to a radio network controller.

23. A computer program product comprising computer-executable instructions embodied in a computer-readable medium for performing steps comprising:
(a) generating user data packets for testing a packet-based communications node;
(b) passing the user data packets downward through a communication protocol stack;
(c) at a predetermined layer in the communications protocol stack, searching the packets for a predetermined key value; and
(d) in response to detecting a packet having the key value, storing the packet and replicating the packet to the packet-based communications node under test.

24. The computer program product of claim 23 wherein searching the packets for a predetermined key value includes searching the packets for a GPRS tunnel protocol identifier.

25. The computer program product of claim 23 wherein searching the packets for a predetermined key value includes searching the packets for an Internet protocol address.

26. The computer program product of claim 23 wherein replicating the packet to the packet-based communications node under test includes replicating the packet to a signaling GPRS support node (SGSN).

27. The computer program product of claim 23 wherein replicating the packet to the packet-based communications node under test includes replicating the packet to a gateway GPRS support node (GGSN).

28. The computer program product of claim 23 wherein replicating the packet to the packet-based communications node under test includes replicating the packet to a radio network controller (RNC).
